(19) United States
(12) Patent Application Publication
(10) Pub. No.: US 2013/0325563 A1
(43) Pub. Date: Dec. 5, 2013

(54) SYSTEMS AND METHODS FOR MAXIMIZING PROFITS AND OPPORTUNITIES FOR TAXI DRIVERS

(71) Applicant: TAI CHEUNG POON, Hong Kong (HK)

(72) Inventor: TAI CHEUNG POON, Hong Kong (HK)

(21) Appl. No.: 13/486,906

(22) Filed: Jun. 1, 2012

(51) Int. Cl. G07B 15/02

(52) U.S. Cl. 705/13

(57) ABSTRACT

Systems and methods are provided for maximizing profits and opportunities for taxi drivers. In one embodiment, a system is provided. The system includes a taximeter installed in taxis, a GPS included in the taximeter; a hand-waving movement detector included in the taximeter, a computing server; a smart device included in the taximeter, wherein the smart device communicate with the computing server to send and extract taxi demand information to and from the computing server; a wireless emitter included in the smart device; and a camera included in the hand-waving movement detector.

### FIELD OF THE INVENTION

This invention generally relates to systems and methods for helping taxi drivers to decide how to make the most profits legally. Specifically, this invention relates to locating the best customers for taxi drivers, using latest technologies in telecommunication and computer technologies.

### BACKGROUND OF THE INVENTION

The name taxi was taken from the word taximeter. Traditionally, taximeter is an instrument which measures the distance or time a vehicle travels, and allows an accurate fare to be determined. Moreover, a taximeter is a mechanical and electronic device installed in a taxicab allowing taxi drivers to easily calculate how much it takes during a trip, whereas no dispute could arise because the taximeter is usually placed right in front of the driver's front panel. The placement is easily seen not just by the taxi driver but also by the passengers sitting back. In the modern world, with the emergence of information technologies, taximeters now become more sophisticated. Modern designs can include accessories, or act as components in larger dispatching or control systems. These features include, for example, ticket or receipt printer, devices for fraud detection and prevention, with superb computer monitoring and control More, new designs may include various configuration of radio communication, which allows trip status to be monitored by a dispatcher or supervisor. By using these mechanisms, taxi drivers can manually communicate with one another to know about the actual road environment, and make adjustment accordingly. The problem is that, given the modern designs, most common taximeters do not link with other taxis but only human controllers. When a driver finds out that certain areas are full of customers waiting for taxis, it is up to the driver to design whether to report the surge in demand to the control center. If there is a mechanism that can share information automatically, there is more mutual benefit to taxi drivers as a whole.

### SUMMARY OF THE INVENTION

According to embodiments of the present invention, an taxi system for maximizing profits and opportunities for taxi drivers is provided. The system comprises: a taximeter installed in taxis, wherein the taximeter recalls costs of a given trip, duration of the given trip, distance of the given trip, customer picked up location, and time of picked up; a GPS included in the taximeter, wherein the GPS determines the customer picked up location; a hand-waving movement detector included in the taximeter, wherein the hand-waving movement detector detects number of hands holding up, which helps determine demand of taxis at a certain location; a computing server; a smart device included in the taximeter, wherein the smart device communicate with the computing server to send and extract taxi demand information to and from the computing server; a wireless emitter included in the smart device; a camera included in the hand-waving movement detector, wherein the camera captures the number of hands holding up; a processor associated with the smart device; and a memory associated with the smart device.

In another related embodiment, the method comprise capturing the taxi demand information by a first taxi at a particular time at a first location, wherein the capturing includes using the hand-waving movement detector to detect the number of hands holding up; detecting the number of hands holding up at the first location are plenty; sending, by the first taxi, the taxi demand information to the computing server; capturing the taxi demand information by a second taxi at a particular time at a second location, wherein the capturing includes using the hand-waving movement detector to detect the number of hands holding up;

The embodied system may be configured to handle detecting the number of hands holding up at the second location, wherein the number of hands are fewer than the first location; sending, by the second taxi, the taxi demand information to the computing server; extracting both the taxi demand information of the first and second taxi by a third taxi from the computing server, wherein the third taxi is currently located at a third location that is closer to the second location but farther from the first location; and when determined that the demand of taxis is higher at the first location but even though farther from the second location, the third taxi bypass the second location and go directly to the first taxi, in order to pick up to the first location, wherein the demand is highest.

Further, the methods in the present system include capturing the taxi demand information by a first taxi at a particular time at a first location, wherein the capturing includes using the hand-waving movement detector to detect the number of hands holding up; detecting the number of hands holding up at the first location are plenty; picking up a customer by the first taxi for a first trip; recording other information for the first trip, wherein the other information includes the duration of the trip, total costs of the trip, and the total distance of the trip; sending, by the first taxi, the taxi demand information and the other information to the computing server; capturing the taxi demand information by a second taxi at a particular time at a second location, wherein the capturing includes using the hand-waving movement detector to detect the number of hands holding up ; detecting the number of hands holding up at the second location, wherein the number of hands are fewer than the first location; picking up a customer by the first taxi for a second trip; recording other information for the second trip, wherein the other information includes the duration of the trip, total costs of the trip, and the total distance of the trip; sending, by the second taxi, the taxi demand information and the other information to the computing server; extracting both the taxi demand and other information of the first and second taxi by a third taxi from the computing server, wherein the third taxi is currently located at a third location that is closer to the second location but farther from the first location; determining whether the first or second location provides a greater return, in light of both the demand information and the other information, especially considering distance and time for the third taxi to travel extra distance and consume more time to the first location; and if determined that the first location yields a better chance of greater return, bypassing the second location and go directly to the first taxi.

### BRIEF DESCRIPTION OF THE DRAWINGS

FIG. 1 illustrates an exemplary system of taxi maximization system.

### DETAILED DESCRIPTION

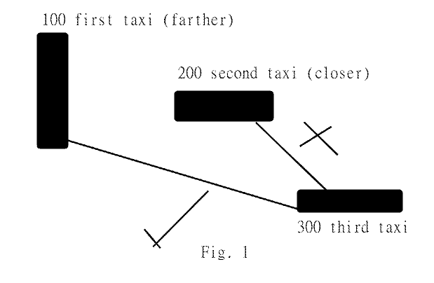

Referring to FIG. 1 for illustration of an embodiment of the inventive taxi system for maximizing profits and opportunities for taxi drivers. The system comprises: a taximeter installed in taxis, wherein the taximeter recalls costs of a given trip, duration of the given trip, distance of the given trip, customer picked up location, and time of picked up; a GPS included in the taximeter, wherein the GPS determines the customer picked up location; a hand-waving movement detector included in the taximeter, wherein the hand-waving movement detector detects number of hands holding up, which helps determine demand of taxis at a certain location; a computing server; a smart device included in the taximeter, wherein the smart device communicate with the computing server to send and extract taxi demand information to and from the computing server; a wireless emitter included in the smart device; a camera included in the hand-waving movement detector, wherein the camera captures the number of hands holding up; a processor associated with the smart device; and a memory associated with the smart device, the memory storing instructions that cause the processor to execute a method.

A number of methods can be used to deploy the inventive system. One method comprises capturing the taxi demand information by a first taxi at a particular time at a first location, wherein the capturing includes using the hand-waving movement detector to detect the number of hands holding up; detecting the number of hands holding up at the first location are plenty; sending, by the first taxi, the taxi demand information to the computing server; capturing the taxi demand information by a second taxi at a particular time at a second location, wherein the capturing includes using the hand-waving movement detector to detect the number of hands holding up; detecting the number of hands holding up at the second location, wherein the number of hands are fewer than the first location; sending, by the second taxi, the taxi demand information to the computing server; extracting both the taxi demand information of the first and second taxi by a third taxi from the computing server, wherein the third taxi is currently located at a third location that is closer to the second location but farther from the first location; and when determined that the demand of taxis is higher at the first location but even though farther from the second location, the third taxi bypass the second location and go directly to the first taxi, in order to pick up to the first location, wherein the demand is highest.

Further, another variation of taxi system with features for maximizing profits and opportunities for taxi drivers are shown, comprising a taximeter installed in taxis, wherein the taximeter recalls costs of a given trip, duration of the given trip, distance of the given trip, customer picked up location, and time of picked up; a GPS included in the taximeter, wherein the GPS determines the customer picked up location; a hand-waving movement detector included in the taximeter, wherein the hand-waving movement detector detects number of hands holding up, which helps determine demand of taxis at a certain location; a computing server; a smart device included in the taximeter, wherein the smart device communicate with the computing server to send and extract taxi demand information to and from the computing server; a wireless emitter included in the smart device; a camera included in the hand-waving movement detector, wherein the camera captures the number of hands holding up; a processor associated with the smart device; and a memory associated with the smart device, the memory storing instructions that cause the processor to execute a method, the method comprising: capturing the taxi demand information by a first taxi at a particular time at a first location, wherein the capturing includes using the hand-waving movement detector to detect the number of hands holding up; detecting the number of hands holding up at the first location are plenty; picking up a customer by the first taxi for a first trip; recording other information for the first trip, wherein the other information includes the duration of the trip, total costs of the trip, and the total distance of the trip; sending, by the first taxi, the taxi demand information and the other information to the computing server; capturing the taxi demand information by a second taxi at a particular time at a second location, wherein the capturing includes using the hand-waving movement detector to detect the number of hands holding up; detecting the number of hands holding up at the second location, wherein the number of hands are fewer than the first location; picking up a customer by the first taxi for a second trip; recording other information for the second trip, wherein the other information includes the duration of the trip, total costs of the trip, and the total distance of the trip; sending, by the second taxi, the taxi demand information and the other information to the computing server; extracting both the taxi demand and other information of the first and second taxi by a third taxi from the computing server, wherein the third taxi is currently located at a third location that is closer to the second location but farther from the first location; determining whether the first or second location provides a greater return, in light of both the demand information and the other information, especially considering distance and time for the third taxi to travel extra distance and consume more time to the first location; and if determined that the first location yields a better chance of greater return, bypassing the second location and go directly to the first taxi.

The hand-waving movement detector detects a number of hand gestures, including number of hands holding up, which helps determine demand of taxis at a certain location; a computing server; a smart device included in the taximeter, wherein the smart device communicate with the computing server to send and extract taxi demand information to and from the computing server; a wireless emitter included in the smart device; a camera included in the hand-waving movement detector, wherein the camera captures the number of hands holding up; a processor associated with the smart device; and a memory associated with the smart device, the memory storing instructions that cause the processor to execute a method, the method comprising: capturing the taxi demand information by a first taxi at a particular time at a first location, wherein the capturing includes using the hand-waving movement detector to detect the number of hands holding up and the taxi demand information includes the current location, as detected by the GPS included in the taxi meter; detecting the number of hands holding up at the first location are plenty; picking up a customer by the first taxi for a first trip; recording other information for the first trip, wherein the other information includes the duration of the trip, total costs of the trip, and the total distance of the trip; sending, by the first taxi, the taxi demand information and the other information to the computing server; capturing the taxi demand information by a second taxi at a particular time at a second location, wherein the capturing includes using the hand-waving movement detector to detect the number of hands holding up; detecting the number of hands holding up at the second location, wherein the number of hands are fewer than the first location; picking up a customer by the first taxi for a second trip; recording other information for the second trip, wherein the other information includes the duration of the trip, total costs of the trip, and the total distance of the trip; sending, by the second taxi, the taxi demand information and the other information to the computing server; extracting both the taxi demand and other information of the first and second taxi by a third taxi from the computing server, wherein the third taxi is currently located at a third location that is closer to the second location but farther from the first location; determining whether the first or second location provides a greater return, in light of both the demand information and the other information, especially considering distance and time for the third taxi to travel extra distance and consume more time to the first location; and if determined that the first location yields a better chance of greater return, bypassing the second location and go directly to the first taxi, and ignoring the passengers on the way to the first location.

What is claimed is:

1. An taxi system for maximizing profits and opportunities for taxi drivers, comprising:
a taximeter installed in taxis, wherein the taximeter recalls costs of a given trip, duration of the given trip, distance of the given trip, customer picked up location, and time of picked up;
a GPS included in the taximeter, wherein the GPS determines the customer picked up location;
a hand-waving movement detector included in the taximeter, wherein the hand-waving movement detector detects number of hands holding up, which helps determine demand of taxis at a certain location;
a computing server;
a smart device included in the taximeter, wherein the smart device communicate with the computing server to send and extract taxi demand information to and from the computing server;
a wireless emitter included in the smart device;
a camera included in the hand-waving movement detector, wherein the camera captures the number of hands holding up;
a processor associated with the smart device; and
a memory associated with the smart device.

2. The system of claim 1, wherein the method comprises:
capturing the taxi demand information by a first taxi at a particular time at a first location, wherein the capturing includes using the hand-waving movement detector to detect the number of hands holding up;
detecting the number of hands holding up at the first location are plenty;
sending, by the first taxi, the taxi demand information to the computing server;
capturing the taxi demand information by a second taxi at a particular time at a second location, wherein the capturing includes using the hand-waving movement detector to detect the number of hands holding up ;
detecting the number of hands holding up at the second location, wherein the number of hands are fewer than the first location;
sending, by the second taxi, the taxi demand information to the computing server;
extracting both the taxi demand information of the first and second taxi by a third taxi from the computing server, wherein the third taxi is currently located at a third location that is closer to the second location but farther from the first location; and
when determined that the demand of taxis is higher at the first location but even though farther from the second location, the third taxi bypass the second location and go directly to the first taxi, in order to pick up to the first location, wherein the demand is highest.

3. The system of claim 1, where the method comprises:
capturing the taxi demand information by a first taxi at a particular time at a first location, wherein the capturing includes using the hand-waving movement detector to detect the number of hands holding up;
detecting the number of hands holding up at the first location are plenty;
picking up a customer by the first taxi for a first trip;
recording other information for the first trip, wherein the other information includes the duration of the trip, total costs of the trip, and the total distance of the trip;
sending, by the first taxi, the taxi demand information and the other information to the computing server;
capturing the taxi demand information by a second taxi at a particular time at a second location, wherein the capturing includes using the hand-waving movement detector to detect the number of hands holding up ;
detecting the number of hands holding up at the second location, wherein the number of hands are fewer than the first location;
picking up a customer by the first taxi for a second trip;
recording other information for the second trip, wherein the other information includes the duration of the trip, total costs of the trip, and the total distance of the trip;
sending, by the second taxi, the taxi demand information and the other information to the computing server;
extracting both the taxi demand and other information of the first and second taxi by a third taxi from the computing server, wherein the third taxi is currently located at a third location that is closer to the second location but farther from the first location;
determining whether the first or second location provides a greater return, in light of both the demand information and the other information, especially considering distance and time for the third taxi to travel extra distance and consume more time to the first location; and
if determined that the first location yields a better chance of greater return, bypassing the second location and go directly to the first taxi.

4. The system of claim 1, wherein the method comprises:
capturing the taxi demand information by a first taxi at a particular time at a first location, wherein the capturing includes using the hand-waving movement detector to detect the number of hands holding up and the taxi demand information includes the current location, as detected by the GPS included in the taxi meter;
detecting the number of hands holding up at the first location are plenty;
picking up a customer by the first taxi for a first trip;
recording other information for the first trip, wherein the other information includes the duration of the trip, total costs of the trip, and the total distance of the trip;
sending, by the first taxi, the taxi demand information and the other information to the computing server;
capturing the taxi demand information by a second taxi at a particular time at a second location, wherein the capturing includes using the hand-waving movement detector to detect the number of hands holding up ;
detecting the number of hands holding up at the second location, wherein the number of hands are fewer than the first location;
picking up a customer by the first taxi for a second trip;
recording other information for the second trip, wherein the other information includes the duration of the trip, total costs of the trip, and the total distance of the trip;
sending, by the second taxi, the taxi demand information and the other information to the computing server;
extracting both the taxi demand and other information of the first and second taxi by a third taxi from the computing server, wherein the third taxi is currently located at a third location that is closer to the second location but farther from the first location;
determining whether the first or second location provides a greater return, in light of both the demand information and the other information, especially considering distance and time for the third taxi to travel extra distance and consume more time to the first location; and
if determined that the first location yields a better chance of greater return, bypassing the second location and go directly to the first taxi, and ignoring the passengers on the way to the first location.

5. An method for maximizing profits and opportunities for taxi drivers, comprising:
capturing taxi demand information by a first taxi at a particular time at a first location, wherein the capturing includes using the hand-waving movement detector to detect a number of hands holding up;
detecting the number of hands holding up at the first location are plenty;
sending, by the first taxi, the taxi demand information to a computing server;
capturing the taxi demand information by a second taxi at a particular time at a second location, wherein the capturing includes using a hand-waving movement detector to detect the number of hands holding up ;
detecting the number of hands holding up at the second location, wherein the number of hands are fewer than the first location;
sending, by the second taxi, the taxi demand information to the computing server;
extracting both the taxi demand information of the first and second taxi by a third taxi from the computing server, wherein the third taxi is currently located at a third location that is closer to the second location but farther from the first location; and
when determined that demand of taxis is higher at the first location but even though farther from the second location, the third taxi bypass the second location and go directly to the first taxi, in order to pick up to the first location, wherein the demand is highest.
